(19) United States
(12) Patent Application Publication
(10) Pub. No.: US 2023/0200936 A1
(43) Pub. Date: Jun. 29, 2023

(54) ENDODONTIC INSTRUMENT, IN PARTICULAR FOR REAMING A ROOT CANAL

(71) Applicant: FKG DENTAIRE SA, La Chaux-de-Fonds (CH)

(72) Inventors: Gianluca ROSATO, La Chaux-de-Fonds (CH); Yann WINKEL, Le Locle (CH); Paul-Henri VALLOTTON, Pampigny (CH); Olivier BREGUET, Le Locle (CH)

(21) Appl. No.: 17/928,520

(22) PCT Filed: May 26, 2021
(86) PCT No.: PCT/IB2021/054580

§ 371 Date: Nov. 29, 2022

(30) Foreign Application Priority Data
May 29, 2020 (CH) 00645/20

(51) Int. Cl. A61C 5/42

(52) U.S. Cl. CPC A61C 5/42

(57) ABSTRACT

The present invention relates to an endodontic instrument comprising a working segment (11) having a working section (110) and terminating in a distal portion (12) having a guiding and cutting function. The distal portion comprises a rounded guide head (13) and an angular cutting section (14). The angular cutting section comprises a distal zone (16) adjacent to the guide head and a proximal zone (17) between the distal zone and the working segment. The angular cutting section (14) further comprises cutting edges (15) extending over the full length of the proximal and distal zones. The distal zone comprises a distal section (160) with constant geometry and the proximal zone comprises a proximal section (170) the geometry of which varies between the distal section and the working section (110).

### TECHNICAL FIELD

The present invention relates to an endodontic instrument notably for reaming a root canal of a tooth of a patient, said instrument having a working length that is terminated by an end zone with a free end in the form of a tip, said end zone having a dual guiding and cutting function.

### STATE OF THE ART

The cleaning and shaping of the root canals of a tooth intended to receive filling substances is performed using reaming instruments that have an active part, called working length, the function of which is to fashion, trim and clean the inner walls of the root canal to prepare it to receive the treatment and filling materials in order to avoid any accumulation of oxygen in the canal, likely to promote a bacterial development in the tooth.

It is however essential for the practitioner to have an instrument that is capable of following the root canal in order to treat the walls without deviating from the direction of this canal regardless of its configuration. Now, the following of the root canal is primarily linked to the guiding characteristics of the end zone and more specifically to the geometry of the tip. Nevertheless, even if the guiding is an essential function, the machining of the walls of the canal is also an essential function, such that the end zone, and notably the tip, must absolutely be configured to be able to effectively fulfil these two functions that are the guiding and the cutting. Then comes the removal of material which is performed by the working length of the instrument, which prolongs the end zone and which, as is known, has the cutting function, the function of machining of the walls of the root canal and the function of evacuating the material removed in the machining.

In practice, the preparation of the canal is performed with a range of instruments all having guiding characteristics in the end zone then cutting and removed material evacuation characteristics in the working zone. The practitioner usually begins the preparation of the canal with an instrument of nominal diameter matched to the initial diameter of the tooth canal, then he or she replaces the first instrument with an instrument of the same type that has a greater nominal diameter, and so on, gradually increasing the sections of the instruments.

The existing instruments mostly have a guiding tip which does not have a cutting function, such that it is essential to use a range of instruments whose diameters increase very gradually, for example with pitches of 0.05 mm, which dictates a sequence of six instruments for the practitioner when changing from an entry diameter of 0.10 mm to 0.40 mm. If this process is not observed, the risk of the instrument breaking in the canal is considerably increased.

There are however so-called active tip instruments that make it possible, with a cutting effect at the center, to penetrate into a canal of very small dimension. However, according to the usage guidelines, these instruments are to be used exclusively for retreatment operations and only in the rectilinear part of the canal. A use in a curved part of the canal would automatically result in perforations of the canal wall.

The document CH707745 from the present applicant describes an endodontic instrument having a working length that is terminated by an end zone with an end in the form of a tip. FIGS. 1a and 1b respectively show a longitudinal cross-sectional view and a transverse cross-sectional view of the end zone 12. The end zone 12 comprises, on the one hand, a tapered guiding segment 13 that is terminated in a tip, this guiding segment 13 having a tip angle of between 10° and 60°. On the other hand, the end zone 12 comprises an angular cutting segment 14 adjacent to the tapered guiding segment 13, comprising several cutting edges 15, forming an angle with respect to the central longitudinal axis of the instrument. This angular cutting segment 14 extends over a certain length and is intermediate between the tapered guiding segment 13 and the working length 11. This angular cutting segment 14 has a section that increases progressively from the base of the tapered guiding segment 13, over at least a part of its length, toward the working length 11 of the instrument 10. There are three cutting edges 15, equally distributed around the periphery of the instrument 10. The tip 16 of the instrument is softened with a rounded profile, which allows the instrument to assume a guiding function allowing it to follow the line of the root canal regardless of its form and notably its curvature.

The penetration of the instrument 10 described in CH707745 is represented schematically in a rectilinear canal 30 by FIG. 2 and in a curved canal 30 by FIG. 3. In the rectilinear canal, the instrument is chosen such that its optimal cutting diameter D3 corresponds to the initial diameter of the canal. The machining of the canal 30 can be performed effectively and the widening of the canal is done gradually until it reaches the nominal diameter of the instrument 10. By virtue of the geometry of the tapered guiding segment 13 of the instrument 10, the latter follows the curvature of the canal 30 without risking perforating the walls and hollowing out a second canal in the tooth.

The cutting function of the tip will allow a reduction in the number of instruments needed for the progression and for the cleaning of the canal to the apex.

### SUMMARY

The present invention sets out to produce an instrument which essentially addresses these two complementary demands, namely to ensure the guiding of the instrument in the penetration into the root canal and to perform the cutting at the walls simultaneously while observing the configuration, that is to say following the curvatures of the canal.

This objective is achieved by the endodontic instrument for the reaming of root canals, the instrument comprising a working length having a working section, the working length being terminated by a distal portion having a dual guiding and cutting function. The distal portion comprises a guide head and an angular cutting segment between the guide head and the working length. The angular cutting segment comprises a distal zone adjacent to the guide head and a proximal zone between the distal zone and the working length. The angular cutting segment further comprises cutting edges that extend over the entire length of the proximal zone and the distal zone. The distal zone comprising a distal section of constant geometry and the proximal zone comprising a proximal section, the geometry of which varies between the distal section and the working section.

The advantage of the endodontic instrument described here lies in a greater instrument cutting efficiency. The distal portion, through its cutting function and through its proximity to the guide head, allows the number of instruments necessary for the progression and for the cleaning of the canal to the apex of the canal to be reduced. The reduction in the number of instruments is even greater than for the instrument described in the document CH707745.

When the endodontic instrument is at the working length, that is to say with the guide head at the apex of the canal, the cleaning of this apical zone of the canal, which is normally very difficult, is made possible by the presence of the cutting edges of the angular cutting segment, in proximity to the guide head. The better cleaning of this apical zone of the canal makes it possible to reduce the risk of subsequent reinfection of the canal (resulting in failure of the treatment), since this zone is particularly sensitive to bacterial development. The better apical machining of the canal by the angular cutting segment of the distal portion facilitates the subsequent steps of the canal treatment, notably the disinfection and filling of the canal. In particular, the better apical machining of the canal will allow an ideal adjustment of the gutta-percha point, in the case of a filling of “single cone” type.

### BRIEF DESCRIPTION OF THE FIGURES

Examples of implementation of the invention are indicated in the description illustrated by the attached figures in which:

FIGS. 1a and 1b show a longitudinal view (FIG. 1a) and a transverse cross-sectional view (FIG. 1b) of an end zone of an endodontic instrument;

FIG. 2 schematically represents the penetration of the instrument of FIGS. 1a and 1b into a rectilinear canal;

FIG. 3 schematically represents the penetration of the instrument of FIGS. 1a and 1b into a curved canal;

FIG. 4 illustrates an endodontic instrument comprising a working length that is terminated by a distal portion, according to an embodiment;

FIG. 5 shows a detail of the distal portion, according to an embodiment;

FIG. 6a shows planes of cross sections at different positions of the distal portion along the longitudinal axis of the instrument;

FIG. 6b shows cross sections of the distal zone according to the different transverse planes of FIG. 6a;

FIG. 7 shows a section of the distal portion along the longitudinal axis of the instrument; and

FIG. 8 shows a detail of a guide head and of the distal zone according to an embodiment.

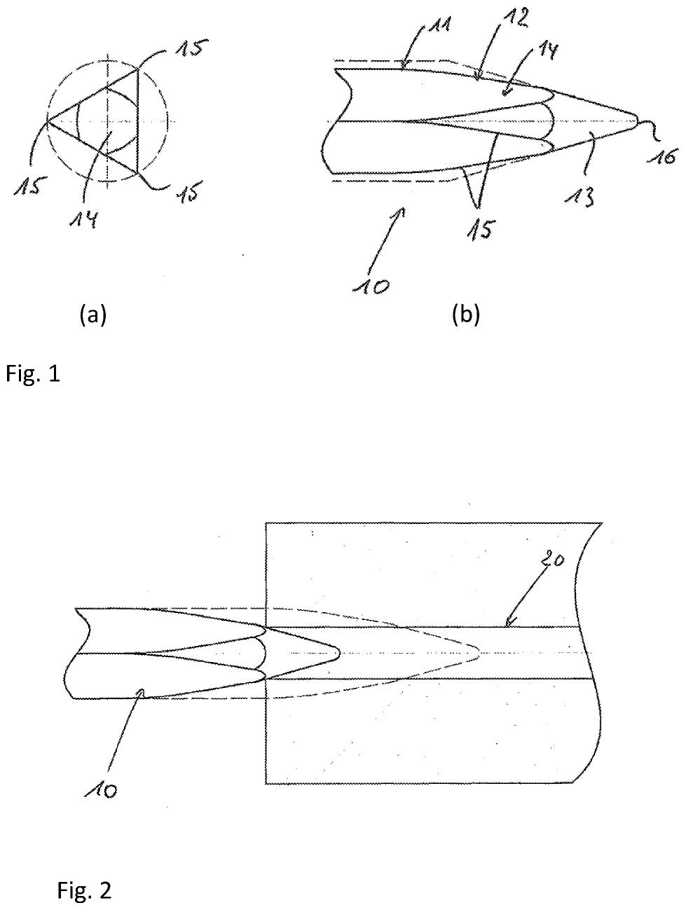

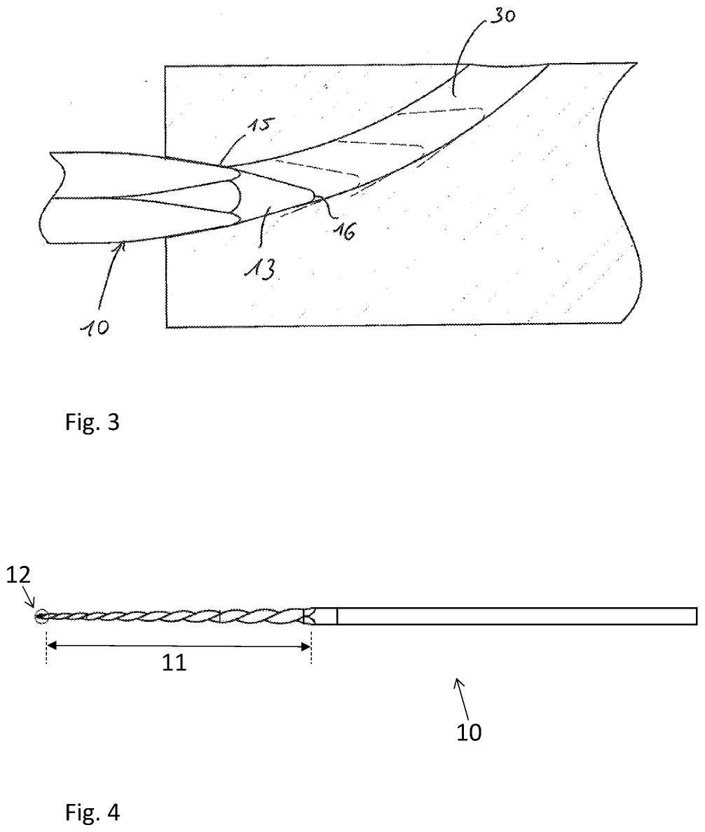

### EXEMPLARY EMBODIMENT(S)

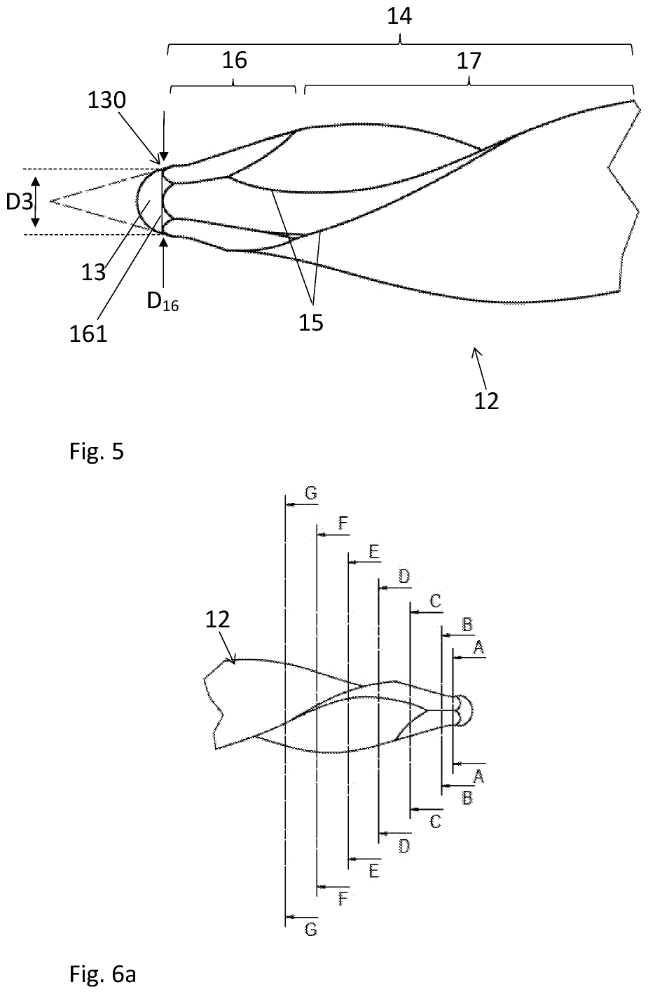

FIG. 4 shows an endodontic instrument 10 intended notably for the reaming of a root canal of a tooth of a patient. The instrument comprises a working length 11 having a working section 110. The working length 11 is terminated by a distal portion 12 that has a dual guiding and cutting function. FIG. 5 shows a detail of the distal portion 12. The distal portion 12 comprises a guide head 13 and an angular cutting segment 14 between the guide head 13 and the working length 11. The angular cutting segment 14 comprises cutting edges 15 forming an angle with respect to the longitudinal axis 20 of the instrument 10. The angular cutting segment 14 comprises a distal zone 16 adjacent to the guide head 13 and a proximal zone 17 between the distal zone 16 and the working length 11. It will be noted that the cutting edges 15 extend over the entire length of the proximal zone 17 and over the entire length of the distal zone 16, to the junction of the guide head 13 and the distal zone 16, indicated by the plane 161 in FIG. 5.

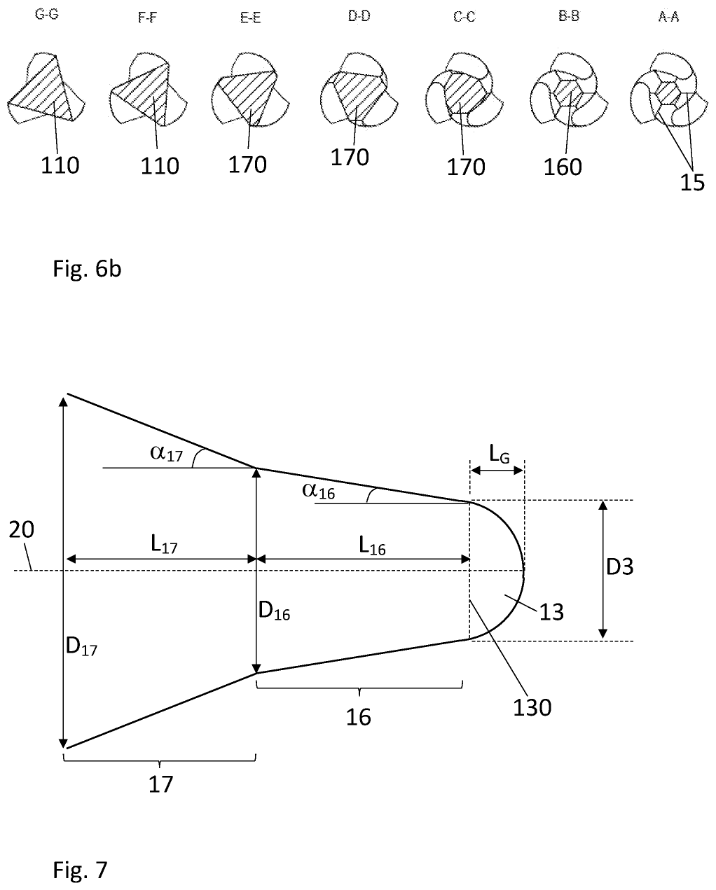

FIGS. 6a and 6b show cross sections A-A, B-B, C-C, D-D, E-E, F-F and G-G, at different positions (FIG. 6a) of the distal portion 12 along the longitudinal axis 20 of the instrument, respectively of the guide head 13 working toward the working length 11. As illustrated in FIG. 6b, the distal zone 16 comprises a distal section 160 of hexagonal geometry forming six cutting edges 15 (cross sections A-A and B-B). The proximal zone 17 comprises a proximal section 170, the geometry of which changes between the hexagonal section 160 of the distal zone 16 and the working section 110 (cross sections C-C, D-D, E-E, F-F and G-G).

The distal section 160 of hexagonal geometry and the distribution of the cutting over the six cutting edges 15 ensure an optimized distribution of the mechanical stresses, minimizing the risk of breakage of the instrument.

For the use of this type of instrument, the following quantities are decisive. The nominal diameters D1 and D2 are the diameters of the circumscribed circle, that is to say the circle in which a cross section of the instrument at the working length 11 (see FIG. 4) is inscribed. The guide head diameter D3 corresponds to the diameter of the proximal base 130 of the guide head, that is to say at the plane 161.

According to one form of execution, the dimension of the distal section 160 of the distal zone 16 is constant. In other words, the circumscribed circle (the circle in which a cross section of the distal zone 16 is inscribed) is of constant diameter. FIG. 6a shows such an example of the distal portion 12 of which the distal zone 16, extending between the cross sections A-A and B-B, has a distal section 160 of constant dimension.

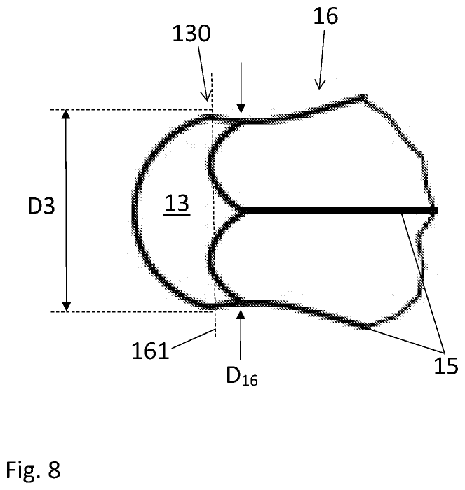

FIG. 7 shows a section of the distal portion 12 along the longitudinal axis 20 of the instrument. According to FIG. 8, the diameter D₁₇ of the proximal zone 17 increases progressively over at least a part of its length L₁₇, between the distal zone 16 toward the working length 11 of the instrument 10. The diameter D₁₆ of the distal zone 16 also increases progressively over at least a part of its length L₁₆, between the guide head 13 and the proximal zone 17. In other words, at least a portion of the distal zone 16 and the proximal zone 17 is tapered and forms, respectively, a distal angle α₁₆ and a proximal angle α₁₇ with the longitudinal axis 20 of the instrument.

According to another form of execution, the distal section 160 of the distal zone 16 and the proximal section 170 of the proximal zone 17 increase progressively over at least a part of the length of the proximal zone 17 and of the distal zone 16, between the guide head 13 toward the working length 11 of the instrument 10.

In one embodiment, the guide head 13 is rounded. As illustrated in FIGS. 5, 6a and 7, the guide head 13 is of substantially hemispherical form (or in dome form).

In yet another embodiment illustrated in FIG. 8, the diameter D3 of the guide head 13 is greater than the diameter D₁₆ of the circumscribed circle of the distal zone 16 over at least a part of the length of the distal zone 16. According to one form of execution, the diameter D3 of the guide head 13 is greater than the diameter D₁₆ of the circumscribed circle of the distal zone 16 at the plane 161.

Once again referring to FIG. 6b (cross sections A-A and B-B), the distal section 160 has the form of a substantially regular hexagon, that is to say whose six sides all have substantially the same length. However, it is also possible to consider the distal section 160 having the form of an irregular hexagon without departing from the scope of the invention.

The proximal section 170 of the proximal zone 17 has a geometry which changes gradually from the hexagonal geometry of the distal section 160 to the geometry corresponding to that of the working section 110, working from the guide head 13 to the working length 11.

For example, and as illustrated in FIG. 6b (cross sections B-B, C-C, D-D, E-E, F-F and G-G), the working section 110 is triangular (cross section G-G) and the proximal section 170 is transformed from a regular hexagonal geometry (cross section B-B) into a triangular geometry (cross sections F-F and G-G), in going through an irregular geometry (cross sections C-C, D-D and E-E).

It goes without saying that the present invention is not limited to the embodiment which has just been described and that various modifications and simple variants can be envisaged by the person skilled in the art without departing from the scope of the present invention.

For example, the working section 110 can have a form other than triangular with three cutting edges. Likewise, the distal zone 16 can comprise a distal section 160 having a geometry which differs from the hexagonal geometry illustrated in FIG. 6b. In particular, at least the working section 110 and/or the distal section 160 can have a section in the form of an “S” with two cutting edges, a triangular section with three cutting edges, a quadrilateral section with four cutting edges, or even a section of more complex form with more than four cutting edges 15.

According to a preferred form of the invention, the ratio L₁₆/L_{G} of the length L₁₆ of the distal zone 16 to the length L_{G} of the guide head 13 is greater than 1. The ratio L₁₆/L_{G} can also be greater than 2, even than 3 or than 5. A high ratio L₁₆/L_{G} means that the guiding edges 15 of the distal zone 16 come right to the end of the angular cutting segment 14, facilitating the apical machining of the canal by the angular cutting segment 14.

The ratio of the length L₁₇ of the proximal zone 17 to the length L₁₆ of the distal zone 16 can be expressed as a function of the distal angle α₁₆, of the proximal angle α₁₇, of the diameter D₁₇ of the proximal zone 17 and the diameter D₁₆ of the distal zone 16. More particularly, the ratio of the length L₁₇ to the length L₁₆ can be expressed by the equation 1:

$$\frac{{L}_{17}}{{L}_{16}} = \frac{( {D}_{17} - {D}_{16} )}{( {D}_{16} - {D}_{3} )} \times \frac{tan {α}_{16}}{tan {α}_{17}} \qquad ( 1 )$$

According to one form of execution, the ratio of the length L₁₇ of the proximal zone 17 to the length L₁₆ of the distal zone 16 is between 0.1 and 10. The ratio of the length of the proximal zone 17 to the length of the distal zone 16 can be between 0.2 and 4.5 or between 0.6 and 1.8.

According to one form of execution, the diameter D₁₆ of the circumscribed circle of the distal zone 16 is constant over the entire length L₁₆ of the distal zone 16. In other words, the distal angle (α₁₆) is substantially 0°.

Similarly, the diameter D₁₇ of the circumscribed circle of the proximal zone 17 can be constant over the entire length L₁₇ of the proximal zone 17.

### REFERENCE NUMBERS EMPLOYED IN THE FIGURES

10 instrument
11 working length
110 working section
12 distal portion, end zone
13 guide head, guiding segment
130 proximal base
14 angular cutting segment
15 cutting edge
16 distal zone, tip
160 distal section
161 plane at the junction of the guide head and the distal zone
17 proximal zone
170 proximal section
20 longitudinal axis
30 canal
α₁₆ distal angle
α₁₇ proximal angle
D1, D2 nominal diameter
D3 guide head diameter
D₁₆ diameter of the distal zone
D₁₇ diameter of the proximal zone
L₁₆ length of the distal zone
L₁₇ length of the proximal zone
L_{G} length of the guide head

1. An endodontic instrument notably for reaming a root canal of a tooth of a patient, the instrument comprising a working length having a working section, the 5 working length being terminated by a distal portion having a dual guiding and cutting function;
the distal portion comprising a rounded guide head and an angular cutting segment between the guide head and the working length;
wherein the angular cutting segment comprises a distal zone adjacent to the guide head and a proximal zone between the distal zone and the working length;
the angular cutting segment further comprising cutting edges that extend over the entire length of the proximal zone and the distal zone;
the distal zone comprising a distal section of constant geometry and the proximal zone comprising a proximal section, the geometry of which varies between the distal section and the working section.

2. The endodontic instrument as claimed in claim 1,
wherein the ratio of the length of the distal zone to the length of the guide head is greater than 1 or is greater than 2.

3. The endodontic instrument as claimed in claim 1, wherein at least one portion of the distal zone and the proximal zone is tapered, respectively forming a distal angle and a proximal angle with the longitudinal axis of the instrument.

4. The endodontic instrument as claimed in claim 1,
wherein the diameter of the guide head is greater than the diameter of the circumscribed circle of the distal zone over at least a part of the length of the distal zone.

5. The endodontic instrument as claimed in claim 4,
wherein the diameter of the guide head is greater than the diameter of the circumscribed circle of the distal zone at the junction of the guide head and of the distal zone.

6. The endodontic instrument as claimed in claim 1,
wherein the ratio of the length of the proximal zone to the length of the distal zone is between 0.1 and 10.

7. The endodontic instrument as claimed in claim 6,
wherein the ratio of the length of the proximal zone to the length of the distal zone is between 0.2 and 4.5 or between 0.6 and 1.8.

8. The endodontic instrument as claimed in claim 1,
wherein the diameter of the circumscribed circle of the distal zone is constant over the entire length of the distal zone.

9. The endodontic instrument as claimed in claim 1,
wherein the diameter of the circumscribed circle of the proximal zone is constant over the entire length of the proximal zone.

10. The endodontic instrument as claimed in claim 1,
wherein the distal section has the form of a substantially regular hexagon.

11. The endodontic instrument as claimed in claim 1,
wherein the distal section has the form of an “S” with two cutting edges, has a triangular form with three cutting edges, or a quadrilateral form with four cutting edges.

12. The endodontic instrument as claimed in claim 1,
wherein the working section is triangular.

13. The endodontic instrument as claimed in claim 1,
wherein the working section has the form of an “S” with two cutting edges, has a triangular form with three cutting edges, or a quadrilateral form with four cutting edges.
